(19) United States
(12) Patent Application Publication
(10) Pub. No.: US 2025/0210877 A1
(43) Pub. Date: Jun. 26, 2025

(54) REFLECTIVE PANEL, ELECTROMAGNETIC WAVE REFLECTING APPARATUS USING REFLECTIVE PANEL, ELECTROMAGNETIC WAVE REFLECTING FENCE, AND METHOD OF MAKING REFLECTIVE PANEL

(71) Applicant: AGC Inc., Tokyo (JP)

(72) Inventors: Shinji UEKI, Tokyo (JP); Kumiko KAMBARA, Tokyo (JP)

(73) Assignee: AGC Inc., Tokyo (JP)

(21) Appl. No.: 19/079,975

(22) Filed: Mar. 14, 2025

Related U.S. Application Data
(63) Continuation of application No. PCT/JP2023/031165, filed on Aug. 29, 2023.

(30) Foreign Application Priority Data
Sep. 26, 2022 (JP) 2022-152154

(51) Int. Cl. H01Q 15/14; H01Q 1/12

(52) U.S. Cl. CPC H01Q 15/141; H01Q 1/12

(57) ABSTRACT

A reflective panel includes a first substrate, a second substrate, and an interlayer in which, a first interlayer film, a second interlayer film, and a third interlayer film are stacked in this order, the interlayer being provided between the first substrate and the second substrate, wherein an interface between the first interlayer film and the second interlayer film, or an interface between the second interlayer film and the third interlayer film is a reflective surface configured to reflect an electromagnetic waves of 1 GHz or more and 300 GHz or less, and wherein d1 and d2 together satisfy 0.5<d1/d2<1.5, where d1 denotes an average thickness of the first interlayer film and d2 denotes an average thickness of the third interlayer film.

### CROSS-REFERENCE TO RELATED APPLICATIONS

This application is a continuation of International Application PCT/JP2023/031165, filed on Aug. 29, 2023 and designated the U.S., which is based on and claims priority to Japanese patent application No. 2022-152154 filed on Sep. 26, 2022, with the Japan Patent Office. The entire contents of these applications are incorporated herein by reference.

### BACKGROUND OF THE INVENTION

### 1. Field of the Invention

The present disclosure relates to a reflective panel, an electromagnetic wave reflecting apparatus using the reflective panel, an electromagnetic wave reflecting fence, and a method of making the reflective panel.

### 2. Description of the Related Art

It is expected that mobile communication technology that enables high-speed and large-capacity communication, low-latency, and numerous simultaneous connections in the fifth-generation mobile communication system (commonly referred to as “5G”) will be introduced into a communication network of the Internet of Things (IoT) which handles a large amount of data. In addition to the mobility and flexibility inherent in mobile communication technology, the low-latency characteristics of 5G are regarded as suitable for IoT. However, since 5G radio waves have strong rectilinearity, it is necessary to secure a propagation path to deliver radio waves to necessary areas by installing reflectors. Taking the introduction of a sixth generation mobile communication system (commonly referred to as “6G”), which uses an even higher frequency band, into consideration, reflectors used to improve the propagation environment are crucial for ensuring accuracy of reflection direction as well as reflection efficiency.

### CITATION LIST

### Patent Literature

[PTL 1] WO No. 2021-199504

In a reflective panel, there is an issue in that the reflection direction and reflection efficiency deviate from the design, and consequently radio waves do not reach a desired area. One object of the present disclosure is to provide a reflective panel that improves at least one of reflection efficiency or accuracy of reflection direction.

### SUMMARY OF THE INVENTION

In one embodiment, provided is a reflective panel, including:
a first substrate;
a second substrate; and
an interlayer in which, a first interlayer film, a second interlayer film, and a third interlayer film are stacked in this order, the interlayer being provided between the first substrate and the second substrate,
wherein an interface between the first interlayer film and the second interlayer film, or an interface between the second interlayer film and the third interlayer film is a reflective surface configured to reflect an electromagnetic waves of 1 GHz or more and 300 GHz or less, and
wherein d1 and d2 together satisfy 0.5<d1/d2<1.5, where d1 denotes an average thickness of the first interlayer film and d2 denotes an average thickness of the third interlayer film.

According to at least one embodiment, a reflective panel in which at least one of reflection efficiency or accuracy of reflection direction is improved can be provided.

### BRIEF DESCRIPTION OF THE DRAWINGS

FIG. 1 is a schematic diagram of an electromagnetic wave reflecting fence, of an embodiment, in which electromagnetic wave reflecting apparatuses having reflective panels are connected together;

FIG. 2 is a horizontal cross-sectional view taken along the A-A line of FIG. 1;

FIG. 3 illustrates an example of a layering configuration of the reflective panel;

FIG. 4 illustrates another example of a layering configuration of the reflective panel;

FIG. 5A is a schematic diagram of the layering configuration of the reflective panel layering of Example 1;

FIG. 5B is an optical micrograph of the reflective panel cross section of Example 1;

FIG. 6A is a schematic diagram of a layering configuration of a reflective panel of Example 5 that is a comparative example; and

FIG. 6B is an optical micrograph of the reflective panel cross section of Example 5.

### DESCRIPTION OF THE PREFERRED EMBODIMENTS

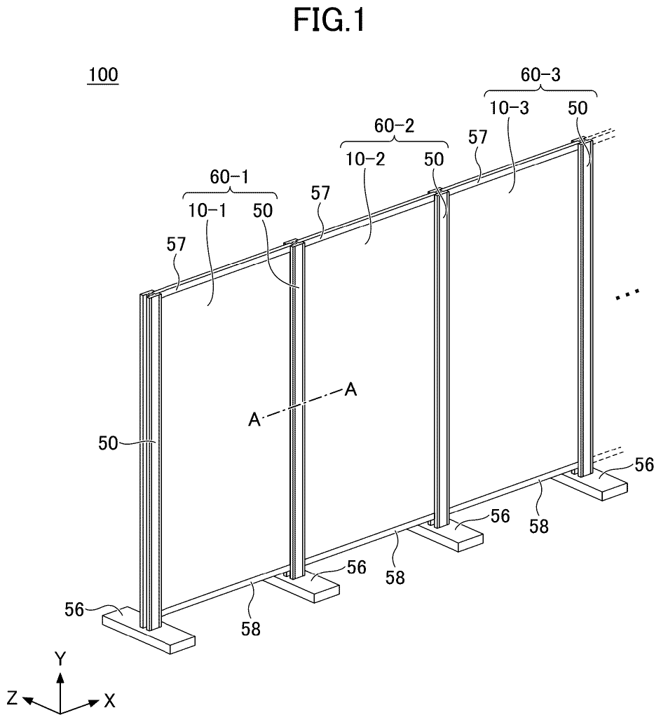

FIG. 1 is a schematic diagram of an electromagnetic wave reflecting fence 100, of an embodiment, in which electromagnetic wave reflecting apparatuses having reflective panels are connected together. The electromagnetic wave reflecting fence 100 is a fence in which electromagnetic wave reflecting apparatuses 60-1, 60-2, and 60-3 respectively having reflective panels 10-1, 10-2, and 10-3 (Hereinafter, collectively referred to as “reflective panel 10” as appropriate.) are connected together in the transverse direction. In the coordinate system of FIG. 1, the width or horizontal direction of the reflective panel 10 is in the X direction, the height or vertical direction is in the Y direction, and the thickness direction is in the Z direction. In FIG. 1, the three electromagnetic wave reflecting apparatuses 60-1, 60-2, and 60-3 (Hereinafter, collectively referred to as “electromagnetic wave reflecting apparatus 60” as appropriate.) connected together make up the electromagnetic wave reflecting fence 100, but the number of electromagnetic wave reflecting apparatuses 60 connected is not particularly limited.

The reflective panels 10-1, 10-2, and 10-3 used in the electromagnetic wave reflecting apparatuses 60-1, 60-2, and 60-3, respectively, reflect an electromagnetic wave in a predetermined frequency band within a range of 1 GHz or more and 300 GHz or less, 1 GHz or more and 170 GHz or less, 1 GHz or more and 100 GHz or less, or 1 GHz or more and 80 GHz or less. As described further below, each reflective panel 10 includes a layer forming a reflective surface. The reflective surface may be a specular reflective surface having equal incident and reflection angles, a metasurface that reflects incident electromagnetic waves in a desired direction, or both.

Each electromagnetic wave reflecting apparatus 60 has a frame 50 configured to hold the reflective panel 10. The electromagnetic wave reflecting apparatus 60 may have legs 56 configured to support the frame 50. The legs 56 are not necessary, but are useful when the electromagnetic wave reflecting apparatus 60 or the electromagnetic wave reflecting fence 100 is meant to be free-standing with respect to an installation plane (XZ plane) as illustrated in FIG. 1.

In the case where the reflective panels 10-1, 10-2, 10-3 have specular reflective surfaces, it is desirable that they are electrically connected to each other from the viewpoint of maintaining the continuity of the reflective potential. However, in the case where they include metasurfaces, there need not be an electrical connection between adjacent reflective panels 10. By holding adjacent reflective panels 10 with the frame 50, the electromagnetic wave reflecting fence 100 connected in the X direction can be obtained.

In addition to the reflective panel 10 and the frame 50, the electromagnetic wave reflecting apparatus 60 may have both a top frame 57 configured to hold an upper end of the reflective panel 10 and a bottom frame 58 configured to hold the lower end of the reflective panel 10. In this case, the frame 50, the top frame 57, and the bottom frame 58 constitute the frame configured to hold the reflective panel 10 around the entire perimeter thereof. The frame 50 may be referred to as a “side frame” because of its position relative to the top frame 57 and the bottom frame 58. The top frame 57 and the bottom frame 58 provide sufficient mechanical strength and ensure safety of the reflective panel 10 during transport and assembly.

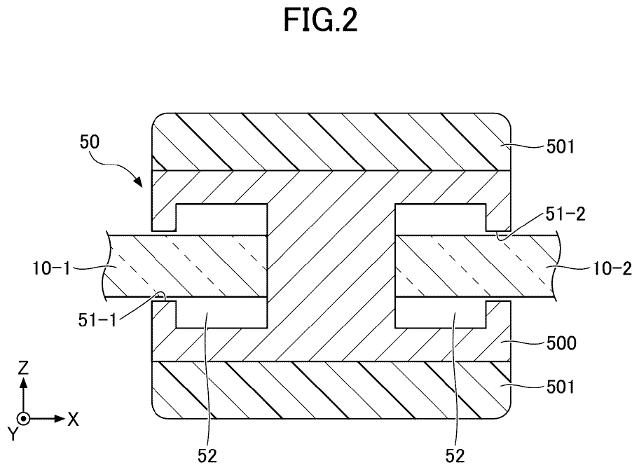

FIG. 2 is a horizontal cross-sectional view taken along the A-A line of FIG. 1. This horizontal cross-sectional view illustrates the reflective panels 10-1 and 10-2 held by the frame 50 in a cross-section parallel to the XZ plane. The frame 50 has a dielectric body 500 and slits 51-1 and 51-2 formed on both sides of the body 500 in the width direction. The edges of the reflective panels 10-1 and 10-2 are inserted into the slits 51-1 and 51-2, respectively, and held within a space 52. The space 52 is not essential, but the inclusion of the space 52 reduces the weight of the body 500 of the frame 50 and allows for a more flexible holding angle of the reflective panel 10 to be relaxed.

By the reflective panels 10-1 and 10-2 into the slits 51-1 and 51-2, respectively, the adjacent reflective panels 10-1 and 10-2 can be stably held. Part of the body 500 may be made of non-dielectric member material. A non-conductive cover 501 such as resin may be provided on the outer surface of the main body 500, but a cover 501 is not required. When the cover 501 is provided, the cover 501 functions as a protective member to protect the frame 50.

### Layering Configuration of Reflective Panel

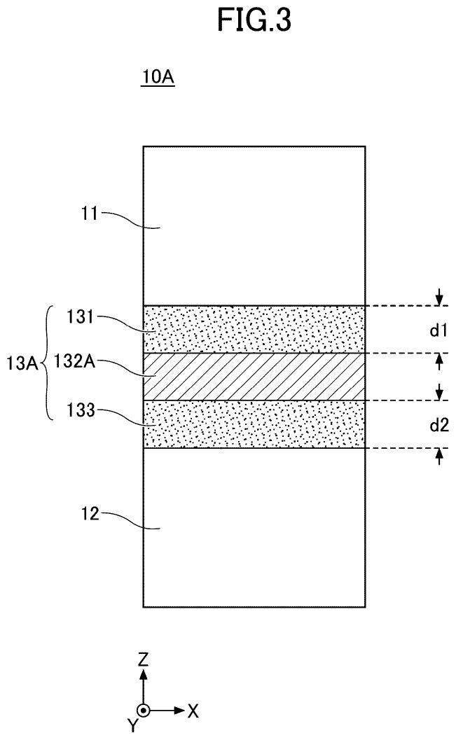

FIG. 3 illustrates an example of a layering configuration of a reflective panel 10A. This layering configuration of the reflective panel 10A is the thickness (Z) direction. The reflective panel 10A has a first substrate 11, a second substrate 12, and an interlayer 13A provided between the first substrate 11 and the second substrate 12. The interlayer 13A has a first interlayer film 131, a second interlayer film 132A, and a third interlayer film 133 stacked in this order. Depending on the incident direction of electromagnetic waves, the interface between the first interlayer film 131 and the second interlayer film 132A or the interface between the second interlayer film 132A and the third interlayer film 133 serves the reflective surface that reflects electromagnetic waves in a predetermined frequency band of 1 GHz or more and 300 GHz or less.

The first substrate 11 and the second substrate 12 support the interlayer 13A from both sides. The first substrate 11 and the second substrate 12 are insulating polymer sheets or films made of materials such as polycarbonate, COP, polyethylene terephthalate (PET), fluororesin, or the like. When the reflective panel 10A is used outdoors or in a production line, it is desirable to use polycarbonate for its excellent impact resistance, durability, and transparency. In order to make the total amount of the reflective panel 10A as light as possible while maintaining the strength of the reflective panel 10A, the thickness of the first substrate 11 and the second substrate 12 is appropriately selected in the range of 1.0 mm or more and 10.0 mm or less.

The second interlayer film 132A is made of a material containing metal and reflects incoming electromagnetic waves. The materials of the second interlayer film 132A can be stainless steel, mild steel, copper oxide, nickel oxide, gold, silver, aluminum, or any combination thereof.

The first interlayer film 131 and the third interlayer film 133 are insulating resin films. Resins such as ethylene vinyl acetate, a cycloolefin polymer (COP), an ultraviolet curing resin, a thermosetting resin, and a thermoplastic resin are used. Urethane-based resins, acrylic-based resins, silicone-based resins, epoxy resins, urethane acrylates, and the like can be used as the ultraviolet curing resins. The materials of the first interlayer film 131 and the third interlayer film 133 may be the same or different, but in order to be able to use the reflective panel 10A from either direction with the same reflective property without distinguishing between the front and back surfaces, it is desirable that they are made of the same material.

The relative permittivity and the dielectric loss tangent of the resin materials of the first interlayer film 131 and the third interlayer film 133 are set in an appropriate range to suppress a decrease in reflection efficiency. The relative permittivity of the above resin materials is 2.0 or more and less than 3.0, and the dielectric loss tangent is 0.0001 or more and less than 0.1000. When the relative permittivity of the first interlayer film 131 and the third interlayer film 133 is 3.0 or more, the loss to high frequencies may increase. Likewise, when the dielectric loss tangent of the first interlayer film 131 and the third interlayer film 133 is 0.1000 or more, the loss of electrical energy in the resin film may increase.

Together, d1 and d2 satisfy 0.5<d1/d2<1.5, where d1 is the average thickness of the first interlayer film 131 and d2 is the average thickness of the third interlayer film 133. Here, the average thickness refers to average thickness obtained by measuring ten points of the reflective panel in the width (X) direction and taking the average of the ten measured points. This condition is the relationship of the film thicknesses in the finished state of the interlayer 13A. If the average thickness of the first interlayer film 131 and the third interlayer film 133 satisfies this condition in the interlayer 13A of the electromagnetic reflective panel 10A, the position of second interlayer film 132A in interlayer 13A can be stabilized, and at least one of reflection efficiency or reflection direction can be well maintained. If the difference in thickness between the first interlayer film 131 and the third interlayer film 133 is large, the second interlayer film 132A comes too close to the surface of interlayer 13A, and consequently the resin film coating becomes insufficient, and air bubbles may occur at the interface between interlayer 13A and either the first substrate 11 or the second substrate 12. Alternatively, the resin film coating of the second interlayer film 132A becomes too thick, and undesirable air bubbles may occur inside the dielectric film.

By keeping the average thickness d1 of the first interlayer film 131 and the average thickness d2 of the third interlayer film 133 in the range of 0.5<d1/d2<1.5, the second interlayer film 132A can be stably maintained in interlayer 13A, and a decrease in reflection efficiency or a degradation in accuracy of reflection direction can be suppressed. It is desirable that the value of d1/d2 satisfies 0.5<d1/d2<1.5, and that the value of d1/d2 is substantially uniform over the entire outer periphery of the reflective panel 10.

Here, d3 denotes the average thickness of second interlayer film 132A. It is desirable that the total thickness of d1, d2, and d3, that is, the average thickness of the interlayer 13A, is smaller than the operating wavelength λ (d1+d2+d3<λ) in the finished state of the interlayer 13A in order to make the design applicable to the whole range of the relevant frequencies of 5G or 6G and to keep reflective panel 10 thin. For example, when the frequency of the electromagnetic wave incident on the reflective panel 10A is 28.0 GHz, the wavelength λ is 10.7 mm, and the thickness of the interlayer 13A is preferably less than 10.7 mm.

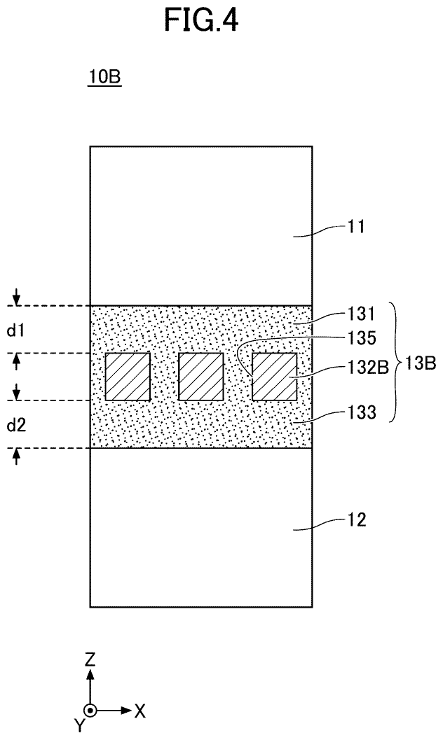

FIG. 4 illustrates an example of a layering configuration of a reflective panel 10B. The reflective panel 10B has the same layering configuration as the reflective panel 10A except that a second interlayer film 132B of the interlayer 13B has an opening 135. The interlayer 13B is held between the first substrate 11 and the second substrate 12. In the interlayer 13B, the first interlayer film 131, the second interlayer film 132B, and the third interlayer film 133 are stacked in this order. Depending on the incident direction of electromagnetic waves, the interface between the first interlayer film 131 and the second interlayer film 132B or the interface between the second interlayer film 132B and the third interlayer film 133 is a reflective surface that selectively reflects electromagnetic waves in a predetermined frequency band of 1 GHz or more and 300 GHz or less. The materials and thicknesses of the first substrate 11, the second substrate 12, the first interlayer film 131, and the third interlayer film 133 are the same as those of the reflective panel 10A.

The opening 135 of the second interlayer film 132B may be a one or more through-holes that are square, circular, elliptical, or polygonal, or may be a mesh opening. The opening 135 that penetrates the second interlayer film may be formed in a periodic arrangement to enhance the selectivity of reflection for a specific frequency. The second interlayer film 132B may be formed in a mesh structure, and thus the mesh opening may be the opening 135 of the second interlayer film 132B. An opening percentage of the second interlayer film 132B is preferably 50% or more and 80% or less in order to keep the visible light transmittance of the reflective panel 10B high while maintaining the reflection efficiency. If the opening percentage exceeds 80%, the desired reflection efficiency may be unobtainable. If the opening percentage is less than 50%, the visible light transmittance of the reflective panel 10B may decrease. If transparency to visible light is not required due to how the reflective panel 10B is used, the opening percentage of the opening 135 may be less than 50% to give priority to improving the reflection efficiency.

The first interlayer film 131 and the third interlayer film 133 may be connected together within the opening 135 of the second interlayer film 132B. The opening 135 need not be completely filled with resin film, but the opening filling percentage may be set to be 90.0% or more of the total area or total volume of the opening 135, depending on the bonding conditions used to form the interlayer 13B. The first interlayer film 131 and the third interlayer film 133 may extend into the opening 135 from both sides of the second interlayer film 132B, or either of the first interlayer film 131 and the third interlayer film 133 may extend into the opening 135.

In the interlayer 13B, the average thickness d1 of the first interlayer film 131 and the average thickness d2 of the third interlayer film 133 together satisfy the condition of 0.5<d1/d2<1.5. As a result, the second interlayer film 132B can be stably held in interlayer 13B, and a decrease in reflection efficiency or a degradation in accuracy of reflection direction can be suppressed. Also, the total thickness of d1, d2, and d3, that is, the thickness of the interlayer 13B, is smaller than the operating wavelength λ (d1+d2+d3<λ), where d3 is the average thickness of the second interlayer film 132B.

In the following, samples were produced under different conditions and the return loss at a given frequency was measured to verify the desirable range of the film thickness relationship between the first interlayer film 131, the second interlayer film 132, and the third interlayer film 133 included in interlayer 13. Return loss was measured using a vector network analyzer and a high-frequency oblique incidence free-space type S-parameter measurement jig. As a reference value of return loss, return loss was measured using a smooth aluminum plate with a thickness of 3 mm and dimensions of 300 mm×300 mm, and this measurement value was set as return loss of 0.00 dB.

### EXAMPLE 1

Example 1 is Example 1 of the present disclosure. A 2-mm-thick polycarbonate sheet was used as the first substrate 11 and the second substrate 12, and the interlayer 13 was placed between the two polycarbonate sheets to prepare a sample of the reflective panel 10. As the design conditions for the interlayer 13, 400-μm-thick ethylene vinyl acetate was used for the first interlayer film 131, 100-μm-thick stainless steel mesh was used for the second interlayer film 132, and 400-μm-thick ethylene vinyl acetate was used for the third interlayer film 133. The average opening diameter of the stainless steel mesh was 268 μm, and the average opening percentage was 71%. This laminate was sandwiched between two sheets of 3-mm-thick glass, and heated under vacuum at 130° C. for 60 minutes to prepare the reflective panel 10. The size of the reflective panel 10 was 1,000 mm×2,000 mm.

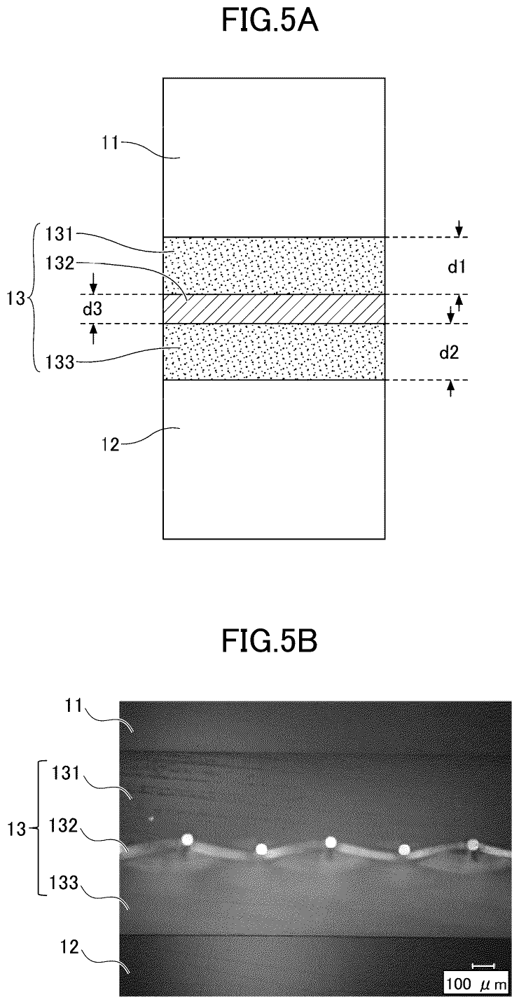

FIG. 5A illustrates a schematic diagram of the layering configuration of the reflective panel of Example 1, and FIG. 5B illustrates an optical micrograph of the sample cross section. In the finished state of the sample of Example 1, the average thickness d1 of the first interlayer film 131 was 400 μm, the average thickness d3 of the second interlayer film 132 was 100 μm, and the average thickness d2 of the third interlayer film 133 was 400 μm. d1/d2=1.0, and thus the condition of 0.5<d1/d2<1.5 was satisfied. Also, d1+d2+d3=900 μm. As illustrated in FIG. 5B, when the appearance of the finished sample was observed, there was no generation of air bubbles within the effective range of 1,000 mm×2,000 mm, and the position of the second interlayer film 132 within interlayer 13 was virtually uniform. When the return loss was measured for the incident electromagnetic wave at 28.0 GHz, it was −0.02 dB compared with an ideal aluminum plate reflector, and the reflection attenuation was very small. Since the wavelength λ at 28 GHz was 10.7 mm, the condition of d1+d2+d3<λ was also satisfied. The reflective property of the sample prepared in Example 1 is good.

### EXAMPLE 2

Example 2 is Example 2 of the present disclosure. A 2-mm-thick polycarbonate sheet was used as the first substrate 11 and the second substrate 12, and the interlayer 13 was placed between the two polycarbonate sheets to prepare a sample of the reflective panel 10. The design conditions for the interlayer 13 were the same as in Example 1. The first interlayer film 131 was 400-μm-thick ethylene vinyl acetate, the second interlayer film 132 was 100-μm-thick stainless steel mesh, and the third interlayer film 133 was 400-μm-thick ethylene vinyl acetate. The conditions for the stainless steel mesh were the same. In the bonding process, the laminated described above was sandwiched between two sheets of 3-mm-thick glass and heated under vacuum at 90° C. for 60 minutes to prepare the sample of Example 2. The size of the reflective panel 10 was 1,000 mm×2,000 mm.

With the sample in the finished state, the average thickness d1 of the first interlayer film 131 was 400 μm, the average thickness d3 of the second interlayer film 132 was 100 μm, and the average thickness d2 of the third interlayer film 133 was 350 μm. d1/d2=1.1, and thus the condition of 0.5<d1/d2<1.5 was satisfied. d1+d2+d3=850 μm, and thus d1+d2+d3<λ was also satisfied. The appearance of the finished sample illustrates that there were no air bubbles within the effective range of 1,000 mm×2,000 mm. When the return loss was measured for the incident electromagnetic wave of 28.0 GHz, it was confirmed that the reflection attenuation was very small, being −0.03 dB compared with the ideal aluminum plate reflector.

### EXAMPLE 3

Example 3 is Example 3 of the present disclosure. A 2-mm-thick polycarbonate sheet was used as the first substrate 11 and the second substrate 12, and the interlayer 13 was placed between the two polycarbonate sheets to prepare a sample of the reflective panel 10. The design conditions for the interlayer 13 were the same as in Example 1. The first interlayer film 131 was 400-μm-thick ethylene vinyl acetate, the second interlayer film 132 was 100-μm-thick stainless steel mesh, and the third interlayer film 133 was 400-μm-thick ethylene vinyl acetate. The conditions for the stainless steel mesh were also the same. In the bonding process, the laminate described above was sandwiched between two sheets of 3-mm-thick glass, and heated under vacuum at 88° C. for 60 minutes to prepare the sample of Example 2. The size of the reflective panel 10 was 1,000 mm×2,000 mm.

With the sample in the finished state, the average thickness d1 of the first interlayer film 131 was 400 μm, the average thickness d3 of the second interlayer film 132 was 100 μm, and the average thickness d2 of the third interlayer film 133 was 285 μm. d1/d2=1.4, and thus the condition of 0.5<d1/d2<1.5 was satisfied. Also, d1+d2+d3=785 μm, and the condition of d1+d2+d3<λ was satisfied. Observing the appearance of the finished sample, no air bubbles were generated within the effective range of 1,000 mm×2,000 mm. When the return loss was measured for the incident electromagnetic wave of 28.0 GHz, it was confirmed that the reflection attenuation was small, being −0.20 dB compared with the ideal aluminum plate reflector.

### EXAMPLE 4

Example 4 is Comparative Example 1. The design conditions were the same as in Examples 1 to 3. That is, 2-mm-thick polycarbonate sheets was used as the first substrate 11 and the second substrate 12, and the interlayer 13 was placed between the two polycarbonate sheets to prepare a sample reflective panel 10. The design values of the interlayer 13 were as follows: the first interlayer film 131 was 400-μm-thick ethylene vinyl acetate, the second interlayer film 132 was 100-μm-thick stainless steel mesh, and the third interlayer film 133 was 400-μm-thick ethylene vinyl acetate. The conditions for the stainless steel mesh were also the same. In the bonding process, the above laminate was sandwiched between two sheets of 3-mm-thick glass and heated under vacuum at 80° C. for 60 minutes to prepare the sample of Example 3. The size of reflective panel 10 was 1,000 mm×2,000 mm.

In the finished state of the sample, the average thickness d1 of the first interlayer film 131 is 400 μm, average thickness d3 of the second interlayer film 132 is 100 μm, and average thickness d2 of third interlayer film 133 is 200 μm. d1/d2=2.0, which is outside the range of 0.5<d1/d2<1.5. When the cross section sample in Example 4 was observed with an optical microscope, 25 air bubbles of about 2 mm to 10 mm in size were observed within the effective range of 1,000 mm×2,000 mm. When the return loss was measured for the incident electromagnetic wave of 28.0 GHz, it was −1.75 dB compared with the ideal aluminum plate reflector, and the reflection attenuation was increased. It is considered that the position of the second interlayer film 132 was biased in the interlayer 13, and the air bubbles were generated in the resin film as a result.

### EXAMPLE 5

Example 5 is Comparative Example 2. The design conditions were the same as in Examples 1 to 4 except for the second interlayer film 132. A 2-mm-thick polycarbonate sheet was used as the first substrate 11 and the second substrate 12, and the interlayer 13 was placed between the two polycarbonate sheets to prepare a reflective panel 10 sample. The first interlayer film 131 and the third interlayer film of the interlayer 13 are 400-μm-thick ethylene vinyl acetate. A 100-μm-thick polyethylene terephthalate film with a 360-nm-thick sputtered Ag-based metal was used as the second interlayer film 132. The above laminate was sandwiched between two sheets of glass 3-mm-thick glass, and heated at 130° C. for 60 minutes under vacuum to prepare the sample of Example 4. The size of the reflective panel 10 is 1,000 mm×2,000 mm.

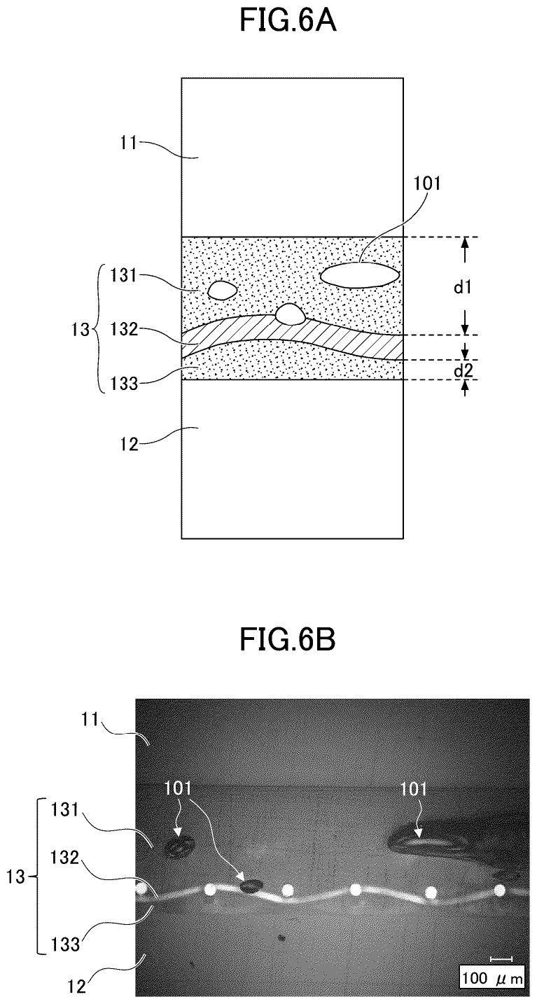

FIG. 6A illustrates a schematic diagram of the layering configuration of the reflective panel of Example 5, and FIG. 6B illustrates an optical micrograph of the sample cross section. With the sample of Example 5 in the finished state, the average thickness d1 of the first interlayer film 131 was 400 μm, and the average thickness d2 of the third interlayer film 133 was 50 μm. d1/d2=8.0, which is outside the range of 0.5<d1/d2<1.5. As illustrated in

FIG. 6B, when the appearance of the finished sample was observed, 125 air bubbles 101 of about 2 mm to 10 mm in size were observed within the effective range of 1,000 mm×2,000 mm. When the return loss was measured for the incident electromagnetic wave of 28.0 GHz, it was −2.20 dB compared with the ideal aluminum plate reflector, and the reflection attenuation was increased. It is considered that this is because the position of the second interlayer film 132 in the interlayer 13 is significantly biased, and as a result, many air bubbles 101 are generated in the resin film, and the relative permeability of the first interlayer film 131 deviates from the designed value.

Thus, in the finished state of the interlayer having a three-layer structure in which the first interlayer film 131 and the third interlayer film 133 sandwich the second interlayer film 132, the average thickness d1 of the first interlayer film 131 and the average thickness d2 of the third interlayer film 133 together satisfy 0.5<d1/d2<1.5. The film thickness relationship between d1 and d2 remained the same even when the first interlayer film 131 and the third interlayer film 133 were reversed. Therefore, if d1/d2 is smaller than 1.5, the d1/d2 becomes larger than 0.5 when viewed from the opposite side. The manufacturing method of the reflective panel 10 is as follows:
(a) The interlayer 13, in which the first interlayer film 131, the second interlayer film 132, and the third interlayer film 133 are laminated in this order, is disposed between the first substrate 11 and the second substrate 12.
(b) The first substrate 11, the interlayer 13, and the second substrate 12 are vacuum pressed at a temperature higher than 80° C. and 130° C. or less, so that the ratio d1/d2 of the average thickness d1 of the first interlayer film 131 to the average thickness d2 of the third interlayer film 133 after the pressing satisfies 0.5<d1/d2<1.5.

As a result, a decrease in reflection efficiency can be suppressed by reducing the return loss. Generation of air bubbles 101 inside the first interlayer film 131 or the third interlayer film 133 can be suppressed, and a deviation of the reflection direction from the designed direction due to the change of refractive index or relative permittivity can be suppressed.

Assuming that the first interlayer film 131 and the third interlayer film 133 together satisfy the condition of 0.5<d1/d2<1.5, it is desirable that the condition of d1+d2+d3<λ be satisfied. Even if d1+d2+d3<λ is satisfied, if it is outside the range of 0.5<d1/d2<1.5, the return loss increases, and it becomes difficult to maintain reflection efficiency or accuracy of reflection direction.

By using the reflective panel 10 described above for the electromagnetic wave reflecting apparatus 60 and the electromagnetic wave reflecting fence 100, the return loss can be reduced, and at least one of reflection efficiency or accuracy of reflection direction can be maintained. The electromagnetic wave reflecting apparatus and the electromagnetic wave reflecting fence using the reflective panel of the embodiment are effectively used in an environment where many dead zones occur in a limited space. In the case where the reflective panel 10 is transparent to visible light, the electromagnetic wave reflecting apparatus and the electromagnetic wave reflecting fence can be used as a safety fence or a soundproof fence.

The in-plane size of the reflective panel 10 can be appropriately selected from 30 cm×30 cm to 3 m×3 m. The entire surface of the reflective panel 10 can be metasurface or a part of it can be specular reflective surface. The first substrate 11 and the second substrate of the reflective panel 10 can be used for a long time in an outdoor environment by providing a protective layer such as an ultraviolet protection film on the surfaces thereof.

Although the embodiments of the present disclosure have been described above, the present disclosure may include the following configurations.

(Item 1) A reflective panel, including:
a first substrate;
a second substrate; and
an interlayer in which, a first interlayer film, a second interlayer film, and a third interlayer film are stacked in this order, the interlayer being provided between the first substrate and the second substrate,
wherein an interface between the first interlayer film and the second interlayer film, or an interface between the second interlayer film and the third interlayer film is a reflective surface configured to reflect electromagnetic waves of 1 GHz or more and 300 GHz or less, and
wherein d1 and d2 together satisfy 0.5<d1/d2<1.5, where d1 denotes an average thickness of the first interlayer film and d2 denotes an average thickness of the third interlayer film.

### Item 2

The reflective panel according to Item 1, wherein a thickness of the interlayer is smaller than a wavelength of an electromagnetic wave incident on the reflective surface.

### Item 3

The reflective panel according to Item 1, wherein the first interlayer film and the third interlayer film are resin layers.

### Item 4

The reflective panel according to Item 3, wherein a relative permittivity of the resin layers is 2.0 or more and 3.0 or less, and a dielectric loss tangent of the resin layers is 0.0001 or more and less than 0.1000.

### Item 5

The reflective panel according to any one of Items 1 to 4, wherein the second interlayer film is a film containing metal.

### Item 6

The reflective panel according to Item 5, wherein the second interlayer film has an opening that is one or more through-holes or a mesh structure.

### Item 7

The reflective panel according to Item 6, wherein an opening ratio of the one or more through-holes or the mesh structure is 50.0% or more and 80% or less.

### Item 8

The reflective film according to Item 6 or 7, wherein the first interlayer film and the third interlayer film are connected together within the opening.

### Item 9

The reflective film according to any one of Items 6 to 8, wherein the opening contains at least one of the first interlayer film or the third interlayer film.

### Item 10

The reflective film according to Item 9, wherein a filling percentage of the opening is 90.0% or more of a total area or a total volume of the opening.

### Item 11

An electromagnetic wave reflecting apparatus, including:
the reflective panel of any one of Items 1 to 10; and
a frame holding the reflective panel.

### Item 12

An electromagnetic wave reflecting fence, comprising:
two or more of said electromagnetic wave reflecting apparatuses of Item 11,
wherein two or more of said reflective panels are connected together by one or more of said frames.

### Item 13

A method of making a reflective panel, the method comprising:
providing an interlayer between a first substrate and a second substrate, the interlayer being an interlayer in which a first interlayer film, a second interlayer film, and a third interlayer film are stacked in this order; and
vacuum pressing the first substrate, the interlayer, and the second substrate at a temperature higher than 80° C. and 130° C. or less such that, after the vacuum pressing, a ratio d1/d2 of an average thickness d1 of the first interlayer film to an average thickness d2 of the third interlayer film satisfies 0.5<d1/d2<1.5.

What is claimed is:

1. A reflective panel, comprising:
a first substrate;
a second substrate; and
an interlayer in which, a first interlayer film, a second interlayer film, and a third interlayer film are stacked in this order, the interlayer being provided between the first substrate and the second substrate,
wherein an interface between the first interlayer film and the second interlayer film, or an interface between the second interlayer film and the third interlayer film is a reflective surface configured to reflect electromagnetic waves of 1 GHz or more and 300 GHz or less, and
wherein d1 and d2 together satisfy 0.5<d1/d2<1.5, where d1 denotes an average thickness of the first interlayer film and d2 denotes an average thickness of the third interlayer film.

2. The reflective panel according to claim 1, wherein a thickness of the interlayer is smaller than a wavelength of an electromagnetic wave incident on the reflective surface.

3. The reflective panel according to claim 1, wherein the first interlayer film and the third interlayer film are resin layers.

4. The reflective panel according to claim 3, wherein a relative permittivity of the resin layers is 2.0 or more and 3.0 or less, and a dielectric loss tangent of the resin layers is 0.0001 or more and less than 0.1000.

5. The reflective panel according to claim 1, wherein the second interlayer film is a film containing metal.

6. The reflective panel according to claim 5, wherein the second interlayer film has an opening that is one or more through-holes or a mesh structure.

7. The reflective panel according to claim 6, wherein an opening ratio of the one or more through-holes or the mesh structure is 50.0% or more and 80% or less.

8. The reflective film according to claim 6, wherein the first interlayer film and the third interlayer film are connected together within the opening.

9. The reflective film according to claim 6, wherein the opening contains at least one of the first interlayer film or the third interlayer film.

10. The reflective film according to claim 9, wherein a filling percentage of the opening is 90.0% or more of a total area or a total volume of the opening.

11. An electromagnetic wave reflecting apparatus, comprising:
the reflective panel of claim 1; and
a frame holding the reflective panel.

12. An electromagnetic wave reflecting fence, comprising:
two or more of said electromagnetic wave reflecting apparatuses of claim 11,
wherein two or more of said reflective panels are connected together by one or more of said frames.

13. A method of making a reflective panel, the method comprising:
providing an interlayer between a first substrate and a second substrate, the interlayer being an interlayer in which a first interlayer film, a second interlayer film, and a third interlayer film are stacked in this order; and
vacuum pressing the first substrate, the interlayer, and the second substrate at a temperature higher than 80° C. and 130° C. or less such that, after the vacuum pressing, a ratio d1/d2 of an average thickness d1 of the first interlayer film to an average thickness d2 of the third interlayer film satisfies 0.5<d1/d2<1.5.
